(19) United States
(12) Patent Application Publication
(10) Pub. No.: US 2008/0142321 A1
(43) Pub. Date: Jun. 19, 2008

(54) Braking System for Motor Vehicles

(75) Inventor: Guntram Ott, Neudeln-Vaduz (LI)

Correspondence Address: MCCORMICK, PAULDING & HUBER LLP, CITY PLACE II, 185 ASYLUM STREET, HARTFORD, CT, 06103, US

(73) Assignee: EVALOR ANSTALT, Vaduz (LI)

(21) Appl. No.: 11/663,419

(22) PCT Filed: Sep. 16, 2005
(86) PCT No.: PCT/EP05/10030

§ 371 Date: Jan. 24, 2008

(30) Foreign Application Priority Data
Sep. 20, 2004 (DE) 10 2004 045 519.8
Jul. 18, 2005 (DE) 10 2005 033 449.0

(51) Int. Cl. B60T 13/12

(52) U.S. Cl. 188/353

(57) ABSTRACT

The invention relates to a braking system for motor vehicles, the system comprising a hydraulic operating brake provided with two separate line circuits (14, 18) connecting a main brake cylinder (20) to brake devices (12) associated with the vehicle wheels by means of an antilock device (16), and a parking brake. According to the invention, an auxiliary cylinder (26) comprising an auxiliary piston (32) that can be displaced by an actuating device (48) and acts on the brake devices (12) during the displacement thereof by means of the liquid columns in the line circuit, and a valve (42) for locking the line connection between the main brake cylinder (20) and the respective brake devices (12), are arranged in at least one of the line circuits (18) between the antilock device (16) and the main brake cylinder (20).

### CROSS-REFERENCE TO RELATED APPLICATIONS

This application is entitled to the benefit of International Application No. PCT/EP2005/010030 filed on Sep. 16, 2005, German Patent Application No. 10 2004 045 519.8 filed on Sep. 20, 2004 and German Patent Application No. 10 2005 033 449.0 filed on Jul. 18, 2005.

The invention concerns a braking system for motor vehicles including a hydraulic operating brake with two separate line circuits which connect a main brake cylinder to the brake devices associated with the vehicle wheels through an anti-lock device, and a parking brake. Numerous attempts have already been made to integrate the parking brake into the customary operating brake system. For example from DE 102 36 686 a brake caliper is known for pinchingly engaging a brake disc rotatably fixed to a vehicle wheel, including a housing, a piston arrangement with a first piston slidably guided in the housing and which piston by way of an operating brake device of the vehicle is movable parallel to the disc axis, and with there being a second piston movable in the housing parallel to the disc axis which second piston works on a brake pad for engagement with the brake disc, with the two pistons enclosing between themselves a pressure space which by means of a connecting channel is connectable with the pressure fluid circuit of a parking brake of the vehicle. If pressure fluid by means of a control valve is conducted into the pressure space between the two pistons, the second piston is then moved and thereby actuates the parking brake. Should the operating brakes be actuated, the pressure in the pressure space is confined by the control valve so that the first and second piston synchronously together with the confined fluid column between them move and actuate the brakes. This solution leads to an increased expense at each braking device, that is at each braked vehicle wheel.

The basic object of the invention is to make possible in a braking system of the aforementioned kind an integration of the parking brake with little additional expense.

This object is solved in accordance with the invention in that in at least one of the line circuits between the anti-locking device and the main brake cylinder an auxiliary cylinder is arranged which auxiliary cylinder by way of a first connection opening and a first line section is connected to the main brake cylinder and by way of a second connection opening and a second line section is connected to the anti-locking device, and which auxiliary cylinder has an auxiliary piston shiftable by an operating device which upon its shifting works on the braking devices through a fluid column in the line circuit, and in that a valve is provided for closing the line connection between the main brake cylinder and the associated braking devices.

By the dosing of the line connection between the main brake cylinder and the braking devices and by the actuation of the auxiliary piston in the direction of a pressure increase at the braking devices all of the braking devices at all of the wheels associated with the involved line circuit can be actuated through the anti-locking device. In contrast to the earlier solution, one therefore needs only a single auxiliary cylinder and one associated piston in the line circuit for the actuation of the parking brake at the wheels associated with the line circuit. Moreover, this auxiliary cylinder can be located where more space stands available as would otherwise be very limited because of the space required by the brake calipers. Accordingly the expense for the integration of the parking brake into the hydraulic operating brake system is considerably reduced and the weight of the brake calipers is also reduced.

Preferably an auxiliary cylinder is arranged in each line circuit so that all wheels of the motor vehicle can be braked by the parking brake. This has the advantage that the necessary braking pressure can be significantly reduced which again leads to the lowering of the expense for the actuating devices working with the auxiliary piston. The two connection openings of the auxiliary cylinder can be so arranged that the end positions of the auxiliary piston lie axially between the two connection openings, with the auxiliary piston having an axial through opening for the brake fluid which by way of the valve in the auxiliary piston can be opened or closed by the shifting of the auxiliary piston.

In a preferred embodiment, the connection openings are so arranged that they in an end position of the auxiliary piston corresponding to a release of the brakes stand in fluid connection with one another, and so that the fluid connection in an end position of the auxiliary piston corresponding to an exertion of brake pressure is broken by the wall of the same auxiliary piston.

An auxiliary cylinder is arranged in each line circuit, and the auxiliary pistons of the two auxiliary cylinders can be moved by a common actuating device or also separately by way of their own actuating devices. The actuation of the auxiliary pistons can be accomplished electromagnetically, mechanically, by way of a pressure fluid, that is hydraulically or pneumatically, or also fluid mechanically. In the latter case, the actuating device in a preferred solution has an actuating cylinder with an actuating piston which is coupled with the auxiliary piston and which is biased in the direction toward an operating position corresponding to brake actuation by a spring and which by a pressure fluid is returnable to its rest position corresponding to a release of the brakes. This embodiment has the advantages that with a pressure fall in the pressure fluid the brakes are automatically actuated by the spring and that no delivery of energy is needed for the holding of the parking brakes.

For the delivery of the pressure fluid to the actuating cylinders, the actuating cylinder is advantageously connected by a pressure line containing at least one actuating valve to a pressure fluid container which, in a way known in itself, is constantly held at a certain pressure by a pump. By an actuation of this actuation valve, the parking brake can be drawn on or released.

Further advantageous developments of the invention are given in the dependent claims.

The following description explains the invention by way of exemplary embodiments with the help of the accompanying figures. The figures are:

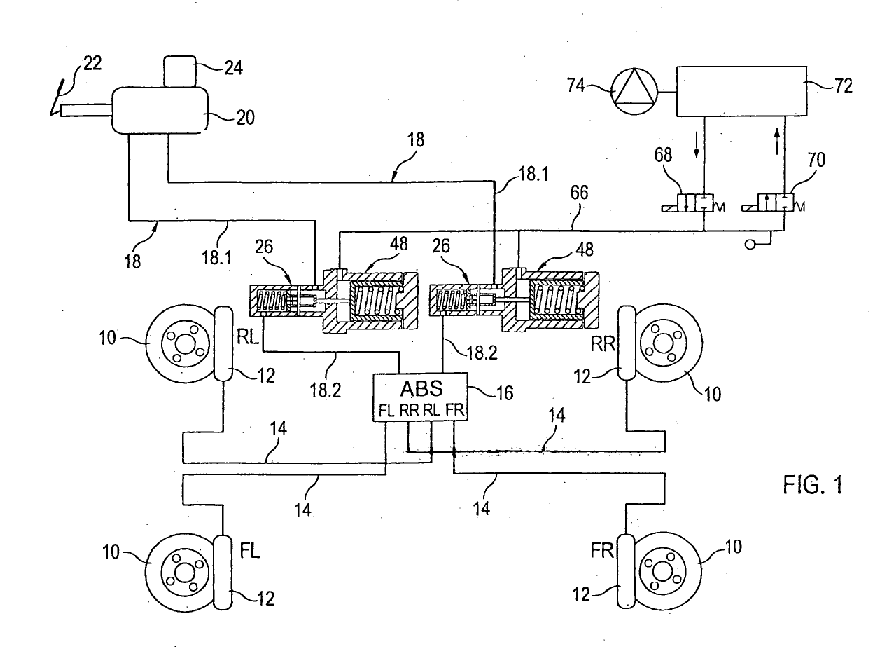

FIG. 1 a schematic illustration of a braking system according to the invention;

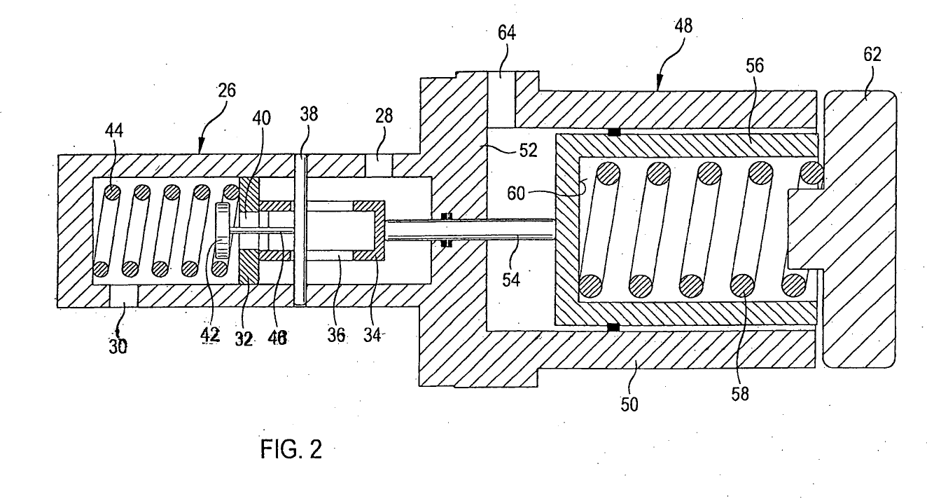

FIG. 2 an axis containing section taken through an auxiliary cylinder and the associated actuating cylinder;

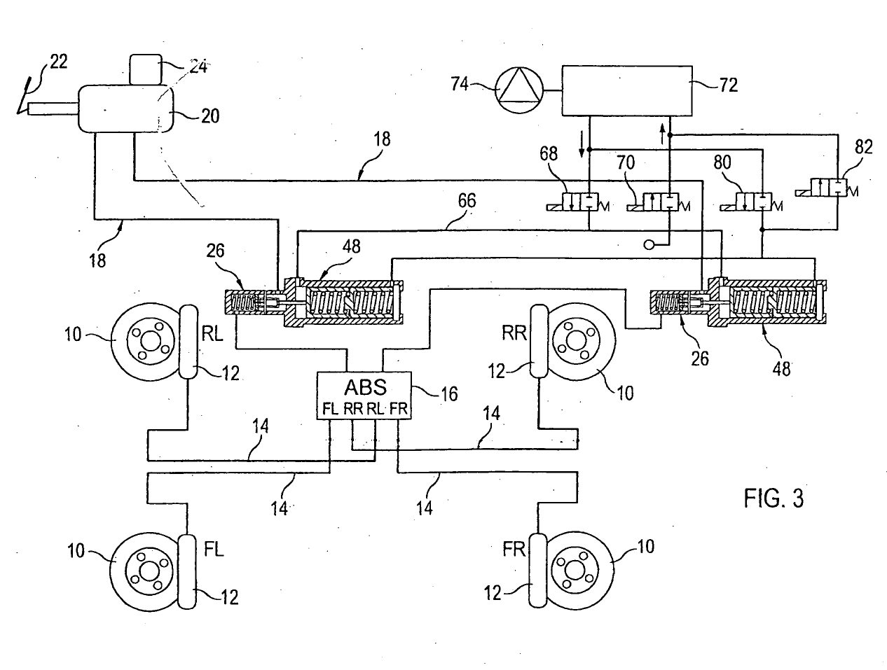

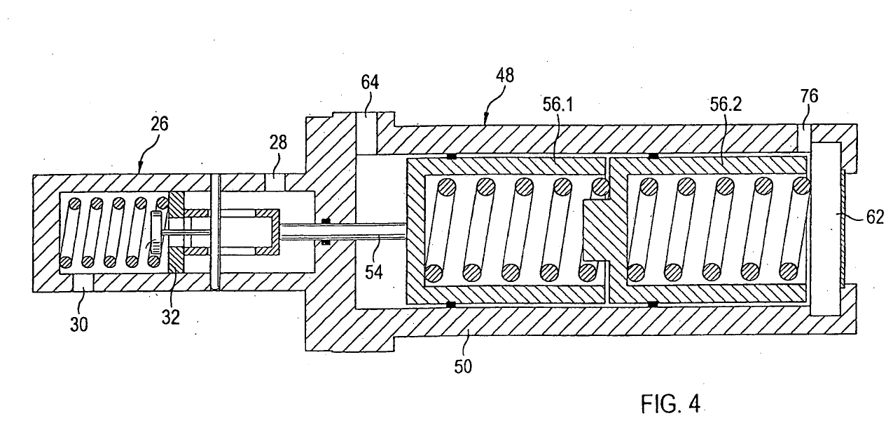

FIG. 3 and FIG. 4 views corresponding to FIG. 1 and FIG. 2 of a modified embodiment of the invention;

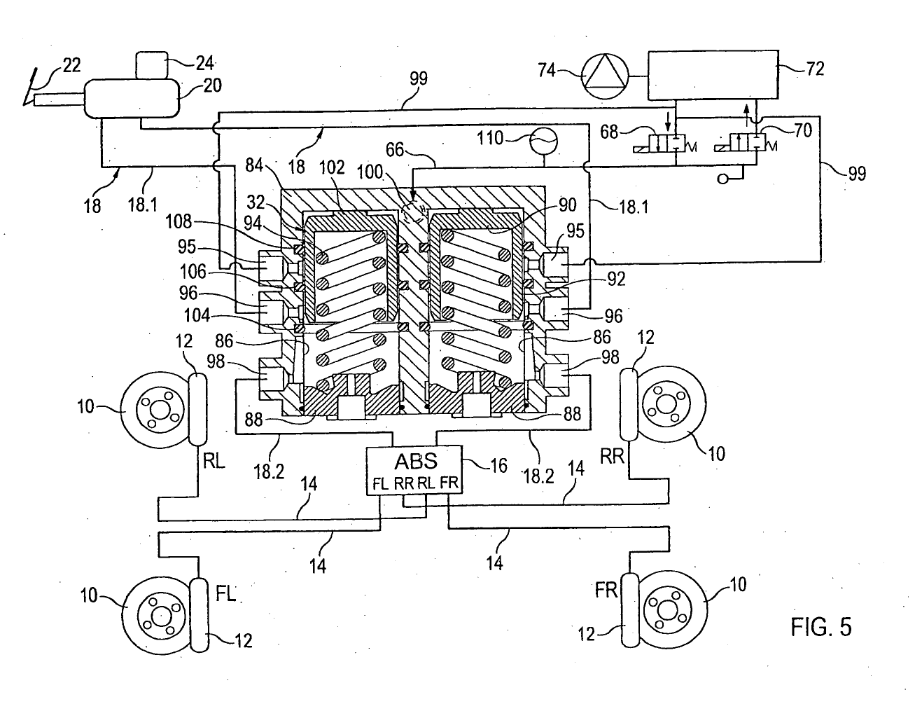

FIG. 5 a view corresponding to FIG. 1 of a further embodiment of the invention;

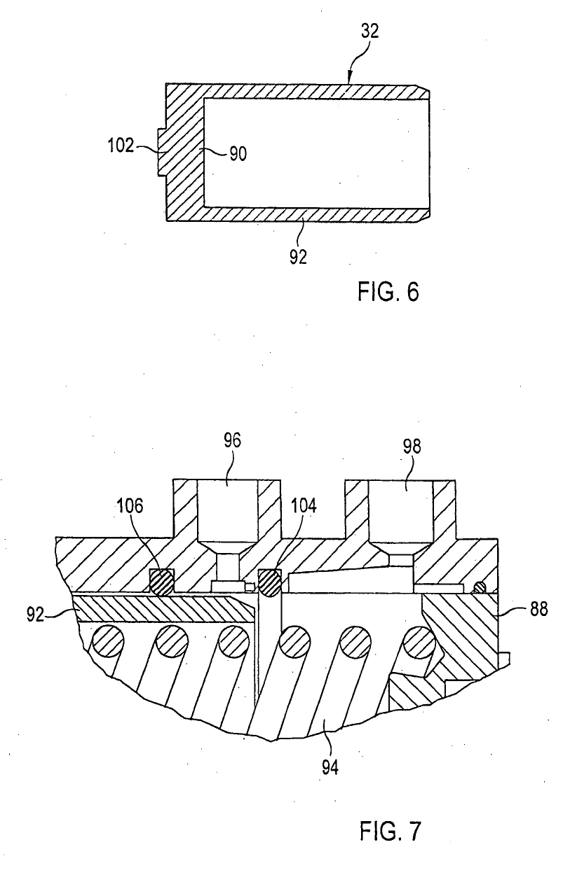

FIG. 6 a schematic sectional view of the auxiliary piston alone; and

FIG. 7 an enlarged illustration of the line connections of the auxiliary cylinder illustrated in FIG. 5.

In FIG. 1, four brake discs of four wheels of a motor vehicle are shown at 10, which wheels are indicated by the letters FL (front left), FR (front right), RL (rear left), and RR (rear right). Each brake disc 10 cooperates with a caliper 12 which is connected by a line 14 with the corresponding connection of an anti-locking device 16 (ABS). The anti-locking device is connected by separate brake lines 18 with a main brake cylinder 20 which is operable by an only schematically illustrated brake pedal 22, and which main brake cylinder 20 stands in connection with a brake fluid container 24. One of the brake lines 18 forms, together with the lines 14 leading to the brake calipers FL and RR, a first braking line circuit, and the other brake line 18 forms, together with lines 14 leading to the brake calipers RL and FR, a second braking line circuit. Both braking line circuits are entirely separated from one another. With the so far described operating braking system, the involvement is that of a customarily operating braking system of a motor vehicle.

Into this operating brake system, there is now incorporated a parking brake which works in such a way that without an actuation of the main brake cylinder 20 a braking pressure can be exerted on the brake calipers 12 and can be held in a locked condition. For this, in each of the two brake lines 18 an auxiliary cylinder 26 is arranged which will now be explained in more detail with reference to FIG. 2. The auxiliary cylinder 26 has, close to its one end, a connector 28 for connection with one of the line sections 18.1 leading to the main brake cylinder 20 and near its other end has a connector 30 for connection with a line section 18.2 of the brake line 18 leading to an anti-locking device 16. In the auxiliary cylinder 26, and between the two connectors 28 and 30, is a slidably supported auxiliary piston 32 connected to a piston rod 34. The piston rod 34 is tubular and has two diametrically opposite axis parallel slots 36 through which a diametrically directed pin 38 fixed in the wall of the auxiliary cylinder 26 runs, which pin limits the shifting movement of the piston rod 34 and of the auxiliary piston 32.

The auxiliary piston 32 has a middle opening 40 which is closable by a valve plate 42. The auxiliary piston 32 is biased towards the right in FIG. 2 by a helical compression spring 44 which on one side engages the cover surface of the auxiliary cylinder 26 and on the other side engages the auxiliary piston 32. The valve plate 42 is connected to a tappet 46 which passes through the opening 40 in the auxiliary piston 32, the length of which tappet is so designed that the tappet pushes against the pin 38 and lifts the valve plate 42 from the auxiliary piston 32 when the auxiliary piston 32 is in the right end position illustrated in FIG. 2. In this position, therefore, brake fluid can flow from the connection 28 through the auxiliary cylinder 26, through the slots 36 into the piston rod 34, through the opening 40 in the piston 32 to the connector opening 30, and the reverse. The sections 18.1 and 18.2 of the brake line 18 are therefore in this position of the auxiliary piston 32 connected with one another. So, in this position of the auxiliary piston the operating brakes can be used in the customary way.

The auxiliary piston 32 is movable by an actuating device 48 as now will be described. The actuating device 48 includes an actuating cylinder 50 which in the illustrated embodiment is formed integrally with the auxiliary cylinder 26 and is separated from it by an intermediate wall 52. A rod 54 runs through this intermediate wall 52 and at its one end lies on the closed end of the piston rod 34 and at its other end is connected to an actuating piston 56 slidably supported in the actuating cylinder 50. The actuating piston 58 is biased by a helical compression spring 58, or optionally a plate spring, which on one hand engages the piston bottom 60 and on the other hand engages a cylinder cover 62 of the actuating cylinder 50, the piston 56 being biased in the direction toward the intermediate wall 52. Near the intermediate wall 52 the actuating cylinder 50 has a connection 64 for a pressure fluid line 66 (FIG. 1) which is connected with a pressure fluid tank 72 by two valves 68, 70, which pressure fluid tank 72 can be pressurized by the pump 74. By way of the valves 68, 70 and the fluid line 66, pressure fluid can be delivered into the actuating cylinder 50 or can be removed from the actuating cylinder 50. In the first case, the actuating piston 56 is set into the position shown in FIG. 2, in which position it is held against the biasing of the helical compression springs 58. If, on the contrary, the valve 70 is opened, so that the pressure fluid can escape from the actuating cylinder 50, the actuating piston 56 becomes unloaded and is moved by the helical compression spring 58 toward the left in FIG. 2 in a direction toward the intermediate wall 52. Thereby the actuating piston 58 by way of the rod 54 and the piston rod 34 of the auxiliary piston 32 shifts to the left in the FIG. 2 against the biasing of the helical compression spring 44. This in turn causes the valve plate 42 by a non-illustrated spring to be pressed against the auxiliary piston 32 since the valve plate 42 is no longer lifted from the auxiliary piston 32 by the tappet 46. Thereby the opening 40 in the auxiliary piston 32 becomes closed and brake pressure is built up and maintained in the line sections 18.2 and as well through the ABS device 16 in the associated lines 14. In this way, the parking brake is pulled on. The brake pressure remains confined and is maintained without further energy delivery. The parking brake is then first again released in that the valve 68 is switched for flow through it and pressure fluid is conducted through the pressure fluid line 66 into the actuating cylinder 50, whereby the actuating piston 56 is pushed into the position illustrated in FIG. 2. The auxiliary piston 32 then moves under the influence of the helical compression spring 42 until the valve plate 42 is lifted from the opening 40 and allows pressure fluid to escape from the brake calipers 12 through the line sections 14, the ABS and the brake line 18.

One will recognize that the parking brake requires only one auxiliary cylinder for each line circuit, independently of the number of brake devices connected to the associated to line circuit. Therefore in contrast to known solutions, the auxiliary cylinder and the associated auxiliary piston need not be supplied for each individual brake caliper.

The embodiment illustrated in FIGS. 3 and 4 differs from the solution according to FIGS. 1 and 2 by way of a modified form of the actuating device. Similar parts are again provided with similar reference numbers. Instead of a single actuating piston, in the embodiment, according to FIGS. 3 and 4 two actuating pistons 56.1 and 56.2 are arranged in the actuating cylinder 50. Further, the actuating cylinder 50 has a further connector 76 which is connected with the pressure fluid tank 72 by way of a further pressure fluid line 76 (FIG. 3) and two further valves 80 and 82. In this way, the rear side of the piston 56.2 can be supplied with pressure fluid through the connector 76 so that the pistons 56.1 and 56.2 are held in the braking position of the parking brake, not only by the spring force of the helical compressions springs 58 but also by the pressure of the hydraulic fluid from the pressure fluid tank 72. Thereby in a simple way, a higher braking pressure can be achieved if this becomes necessary; otherwise the arrangement according to FIGS. 3 and 4 operates in the same way as the arrangement according to FIGS. 1 and 2. It is also to be mentioned that the two line circuits of the braking system are made entirely identically, and also the two auxiliary cylinders and actuating devices in the two brake lines 18 are identical.

The embodiment illustrated in FIGS. 5 to 7 distinguishes itself by its especially simple construction. Again, the same reference numbers have been used for the same parts.

Instead of two separate auxiliary cylinders 26 a common housing 84 is provided which has two cylindrical bores 86 each of which is dosed by a closure element 88 and is designed for the reception of an auxiliary piston 32. The auxiliary piston 32 is pot-shaped with a piston bottom 90 and a piston wall 92. A helical compression spring 94 is received in each hollow auxiliary piston 32, which spring on one side engages the associated closure element 88 and on the other side engages the inner side of the pot bottom 90 and biases the auxiliary piston 32 in the direction toward the associated bottom of its cylindrical bore 86.

Each cylindrical bore 86 has three axially spaced connection openings 95, 96, 98. The middle connection opening 96 is connected to the line section 18.1 which connects the cylinder bore 86 with the main brake cylinder 20. The connection opening 98 lying closest to the closure element 88 is connected by the line section 18.2 to the ABS device 16. The connection opening 95 lying closest to the cylinder bore 86 bottom is connected directly with the supply container 72 by a line 99.

The space between the bottom of the cylindrical bore 86 and the associated piston bottom 90 is connected by a common connector 100 with the pressure fluid line 66. As one will especially see from FIG. 6, the piston bottom 90 of each auxiliary piston 32 has a bump 102 on it outer side so that pressure fluid entering through the connector 100 can reach between the bottom of the cylinder bore 86 and the bottom 90 of the auxiliary piston 32 even when the auxiliary piston 32 is in its end position as illustrated in FIG. 5.

Therefore, the auxiliary piston 32 can be moved against the biasing force of the helical compression spring 94 in the direction toward the associated closure element 88 by the delivery of pressure fluid through the pressure fluid line 66.

Between the two connection openings 96 and 98 an annular groove is formed in the wall of the cylinder bore 86 and receives a first sealing ring 104. Between the connection openings 95 and 96 on one hand and the connection openings 95 and the bottom of the cylinder bore 86 on the other hand are arranged a second and a third sealing ring 106 and 108 in corresponding annular grooves.

The axial length of the auxiliary piston 32 is so chosen that in the end position illustrated in FIG. 5 the connection opening 96 is at least partially made free so that the connection openings 96 and 98 stand in fluid connection with one another by way of the interior space of the cylinder bore 86. If the involved auxiliary piston 32 is then pushed in the direction of the associated closure element 88 by the delivery of pressure fluid through the line 66, the free edge of the piston wall 92 will move past the sealing ring 106 and thereby break the fluid connection between the closure openings 96 and 98. Therefore the braking pressure can be built up in the associated line circuit and a corresponding braking signal can be given to the ABS device. By a closing of the valves 68 and 70, the pressure in the pressure fluid line 66 is locked in so that the auxiliary pistons 32 become fixed in their brake pressure and braking signal creating positions. So that each auxiliary piston 32 upon its movement does not remain hanging at the sealing ring 106 it in the region of its free edge facing the closure element 88 is beveled at its outer side, as can plainly be seen in FIGS. 6 and 7. The bevel angle as a value of about 20° relative to the bore wall. In this way the parking brake can be actuated independently of the actuation of the main brake cylinder.

By a cooling or heating of the pressure fluid, its volume can be considerably changed. This leads to a shifting of the auxiliary pistons in the cylinder bores 86. To deal with this volume and corresponding pressure change, the pressure fluid line 66 is connected to a pressure compensator 110 which can be made as a spring compensator, membrane compensator, or the like. If because of a very large cooling of the system, or because of a leakage, one of the auxiliary pistons is shifted so far that the associated connection opening 95 is made free by the rearward (that is the one facing the bottom of the cylinder bore 86) edge of the auxiliary piston 32, the space between the piston bottom and the bottom of the cylinder bore 86 becomes directly connected with the supply container 72, so that the pressure leaves the auxiliary piston and thus the braking pressure created by it is maintained. If the system should then become warm again, the auxiliary piston will again shift towards the rear and will close the connection opening 95. The volume change thereby effected in the pressure fluid line 66 will again be taken up by the pressure compensator 110.

So that by this movement, the sealing ring 108 is not damaged, the rearward piston end is likewise beveled, similarly to the forward piston end, which can be plainly seen in FIG. 6.

Should it happen that the connection opening 95 is open and one tries to open the parking brake with the releasing valve 70, one must, in this case, also remove the pressure from the supply container 72. This would in turn mean that at this moment with a new actuation of the parking brake, no braking pressure would stand available. To avoid this from happening, in the run to the connection opening 95 is arranged a diaphragm or throttle, the diameter of which is so small that the pressure fluid flows substantially more slowly through the connection opening 95 and into the cylinder bore 86 then can the pressure fluid flow off from the cylinder bore 86 through the connection 100, the fluid line 66 and the releasing valve 70. Therefore, the auxiliary piston can be moved in the direction toward the bottom of the cylinder bore 86 under the effect of the spring 94 so that the connection opening 95 becomes again closed. Then the stored pressure can be delivered quite normally through the release valve 70 to the supply container 72.

The embodiment illustrated in FIGS. 5 to 7 has the advantage that the valve provided for the closing of the line connection between the main brake cylinder and the ABS device has no valve element of its own and instead is formed by the connection opening 96 and the piston wall of the auxiliary piston 32. Accordingly, the moveable valve element 42 provided in the embodiment according to FIGS. 1 to 4 is no longer present. Further, the auxiliary piston 32 for its movement is directly impacted by the pressure fluid so that an actuating cylinder 48 of its own is no longer present as it is in the solution according to FIGS. 1 through 4.

1. A braking system for motor vehicles including a hydraulic operating brake with two separate line circuits (14, 18) which connect a main brake cylinder (20) through an anti-locking device (16) with brake devices (12) associated with vehicle wheels, and a hydraulically operating parking brake, characterized in that in at least one of the line circuits (18) between the anti-locking device (16) and the main brake cylinder (20) is arranged an auxiliary cylinder (26), which through a first connection opening (96) and a first line section (18.1) is connected with the main brake cylinder (20) and by way of a second connection opening (98) and a second line section (18.2) is connected with the anti-locking device (16) and which contains an auxiliary piston (32) which by its shifting is operable to effect a build up of a parking brake pressure through a fluid column in the line circuit on the brake devices (12) and is settable to a position corresponding to the drawing on of the parking brake, and in that a valve (42) is provided for a dosing of the line connection between the main brake cylinder (20) and the associated brake devices (12).

2. A braking system according to claim 1, further characterized in that the two connection openings of the auxiliary cylinder (26) are so arranged that the end positions of the auxiliary piston lie axially between the two connection openings, with the auxiliary piston (32) having an axially through opening (40) for the brake fluid, which through opening (40) can be opened or closed by the valve (42) by the shifting of the auxiliary piston (32).

3. A braking system according to claim 1, further characterized in that the two connection openings (96, 98) are so arranged that they in the end position in the auxiliary piston corresponding to a release of the brakes stand in fluid connection with one another and so that said fluid connection in an end position of the auxiliary piston (32) corresponding to the application of the braking pressure is breakable by the wall (92) of the same auxiliary piston.

4. A braking system according to one of claims 1 to 3, further characterized in that each line circuit (18.1, 18.2) is arranged an auxiliary cylinder (26).

5. A braking system according to claim 4, further characterized in that the auxiliary pistons (32) of the two auxiliary cylinders (26) are moveable by way of a common actuating device.

6. A braking system according to claim 4, further characterized in that each auxiliary piston (32) is moveable by its own actuating device (48).

7. A braking system according to one of claims 1 to 6, further characterized in that the actuating device is formed as an electromagnetically actuated actuating device.

8. A braking system according to one of the claims 1 to 6, further characterized in that the actuating device is formed as a pressure medium actuated actuating device.

9. A braking system according to one of the claims 1 to 6, further characterized in that the actuating device is formed as a mechanically actuated actuating device.

10. A braking device according to one of the claims 1 to 6, further characterized in that the actuating device is formed as a fluid mechanical actuating device.

11. A braking system according to claim 10, further characterized in that the actuating device (48) has an actuating cylinder (50) with an actuating piston (56) which is coupled with the auxiliary piston (32) of the auxiliary cylinder (26) and which by a spring (58) is biased in the direction toward its operating position corresponding to a brake actuation and which is returnable by pressure fluid to its rest position corresponding to a release of the brakes.

12. A braking system according to claim 8, further characterized in that the auxiliary piston is biased by a spring (94) toward its one end position and is shiftable against the biasing of the spring to its other end position by a pressure medium.

13. A braking system according to claim 11 or 12, further characterized in that the actuating cylinder (48) and auxiliary cylinder are connected to a pressure fluid container (72) by a pressure line (68) containing at least one actuating valve (68, 70).
